(19) United States
(12) Patent Application Publication
(10) Pub. No.: US 2005/0190246 A1
(43) Pub. Date: Sep. 1, 2005

(54) Printing method using nozzles with small diameters

(75) Inventors: Karen J. Klingman, Pittsford, NY (US); David A. Griggs, Hilton, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/787,398

(22) Filed: Feb. 26, 2004

(51) Int. Cl. C09D 11/00

(52) U.S. Cl. 347/101

(57) ABSTRACT

This invention relates to an ink jet printing method comprising the steps of: A) providing an ink jet printer that is responsive to digital data signals; B) providing an ink jet printhead comprising a nozzle array comprising a plurality of nozzles, said nozzle array being dedicated to ejecting a given ink jet ink composition, wherein said nozzles are 20 microns or less in diameter;
C) supplying said printhead with said given ink jet ink composition, said ink jet ink composition comprising particles wherein at least 90% by weight of said particles have a diameter that is less than 1/120^{th} of the diameter of said nozzles; and
D) printing using said given ink jet ink composition in response to said digital data signals. It further relates to an ink supply system comprising printed instructions directing that the ink jet supply system be used with an ink jet printer comprising an ink jet printhead comprising a nozzle array comprising a plurality of nozzles, said nozzle array being dedicated to ejecting a given ink jet ink composition, wherein the nozzles are 20 microns or less in diameter; and said ink jet supply system further comprising said given ink jet ink composition comprising particles wherein at least 90% of the particles are less than 1/120^{th} of the diameter of said nozzles. It further relates to an ink jet ink supply system comprising an ink jet ink supply and a printhead meeting the above parameters, and an ink jet printer comprising a printhead and an ink jet ink supply meeting the above parameters.

### FIELD OF THE INVENTION

This invention relates to an ink jet printing method that employs a printhead having small nozzle diameters and an ink composition containing particles. The method enables reliable printing.

### BACKGROUND OF THE INVENTION

Ink jet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand ink jet, individual ink droplets are projected as needed onto the image-recording element to form the desired printed image. Common methods of controlling the projection of ink droplets in drop-on-demand printing include piezoelectric transducers and thermal bubble formation. In another process, known as continuous ink jet, a continuous stream of droplets is charged and deflected in an image-wise manner onto the surface of the image-recording element, while un-imaged droplets are caught and returned to an ink sump. Ink jet printers have found broad applications across markets ranging from desktop document and photographic-quality imaging, to short run printing and industrial labeling.

Most ink jet ink compositions are either aqueous- or solvent-based and are in a fluid state at room temperature. In either case, it is well-known in the art that particles may be employed in an ink composition in order to obtain or improve desired characteristics in the printed image. Pigment-based ink compositions are widely used in the art of ink jet printing, and this term typically refers to ink compositions which are colored due to the presence of pigment particles. Pigment-based inks are often preferred over dye-based inks because they render printed images having higher optical densities and better resistance to light and ozone.

Ink jet ink compositions may also contain non-colored particles such as inorganic particles or polymeric particles. The use of such particulate addenda has increased over the past several years, especially in ink jet ink compositions intended for photographic-quality imaging. For example, U.S. Pat. No. 5,925,178 describes the use of inorganic particles in pigment-based inks in order to improve optical density and rub resistance of the pigment particles on the image-recording element. In another example, U.S. Pat. No. 6,508,548 B2 describes the use of a water-dispersible polymeric latex in dye-based inks in order to improve light and ozone resistance of the printed images.

It is well-known in the art of ink jet printing, especially in recent years, that reliable jetting of ink compositions containing particles is difficult to achieve. Reliable jetting occurs when the individual streams of ink droplets fire continuously from each of the printhead nozzles without any nozzles shutting down, either temporarily or permanently, due to clogging by the particles. Ink jet printing technology is evolving toward the use of smaller and smaller droplet sizes, jetted with printheads having smaller and smaller nozzle diameters, thereby making it increasingly difficult to utilize particles in ink compositions. As such, the size range of particles in ink compositions is beginning to approach a significant proportion of nozzle diameters.

It is well known in the art that monodisperse, or uniformly sized, spheres will pack in an orderly fashion within a cylinder when their diameters reach on the order of 5%-10% of the cylinder's diameter; for example, see Brazilian Journal of Chemical Engineering (1999), 16(4), 395-405; Powder Technology (1992), 72 269-275; and AIChE Journal (1958), 4(4) 460-464). It therefore follows that as the size of monodisperse particles in a given ink composition reaches a certain proportion of a nozzle diameter, the propensity to clog the nozzle will increase, even if the particle size does not exceed the nozzle diameter.

However, the particles used in ink jet ink compositions are not monodisperse, but contain particles having a range of sizes, or particle size distribution. While the average particle size may be small, the presence of a few large particles within the particle size distribution may cause clogging. Determination of the average particle size and/or particle size distribution required to clog nozzles of a certain diameter would be complex mathematically.

U.S. Pat. No. 6,494,943 B1; U.S. Pat. No. 6,562,117 B2; and U.S. 2003/0196571 A1 describe pigment-based ink jet ink compositions having small particle sizes for reliable jetting. The problem with such inks is that they cannot be jetted reliably over extended periods, i.e., when printing hundreds of pages. The particle diameter criteria described by these references are not stringent enough when printing with printheads having small nozzle diameters, particularly 20 microns or less.

### SUMMARY OF THE INVENTION

The present invention provides an ink jet printing method having the steps of A) providing an ink jet printer that is responsive to digital data signals; B) providing an ink jet printhead having a nozzle array having a plurality of nozzles, the nozzle array being dedicated to ejecting a given ink jet ink composition, wherein the nozzles are 20 microns or less in diameter; C) supplying the printhead with the given ink jet ink composition, the given ink jet ink composition containing particles wherein at least 90% by weight of the particles have a diameter that is less than 1/120^{th} of the diameter of the nozzles; and D) printing using the given ink jet ink composition in response to the digital data signals.

It additionally provides an ink jet printer comprising a printhead and an ink jet ink supply, wherein said printhead comprises a nozzle array comprising a plurality of nozzles, said nozzle array being dedicated to ejecting a given ink jet ink composition, wherein said nozzles are 20 microns or less in diameter; and wherein said ink jet ink supply further comprises the given ink jet ink composition comprising particles wherein at least 90% of the particles are less than 1/120^{th} of the diameter of said nozzles. It also provides a method of replenishing the ink supply for a specified printer.

It further provides an ink supply system comprising printed instructions directing that the ink jet supply system be used with an ink jet printer comprising an ink jet printhead comprising a nozzle array comprising a plurality of nozzles, said nozzle array being dedicated to ejecting a given ink jet ink composition, wherein the nozzles are 20 microns or less in diameter; and said ink jet supply system further comprising said given ink jet ink composition comprising particles wherein at least 90% of the particles are less than 1/120^{th} of the diameter of said nozzles. It also provides an ink jet ink supply system comprising an ink jet ink supply and a printhead wherein said printhead comprises a nozzle array comprising a plurality of nozzles, said nozzle array being dedicated to ejecting a given ink jet ink composition, wherein said nozzles are 20 microns or less in diameter; and wherein said ink jet ink supply further comprises the given ink jet ink composition comprising particles wherein at least 90% of the particles are less than 1/120^{th} of the diameter of said nozzles.

The invention provides an ink jet printing method having numerous advantages. The invention provides an ink jet printing method for obtaining hundreds of pages of prints that are free of undesirable image artifacts, such as white spots and banding, known to occur when printhead nozzles shut down either temporarily or permanently. When the method of the invention is utilized, image quality is maximized because the ink compositions will fire nearly identically from printhead nozzles, i.e, with the same jet velocities, direction, droplet sizes, separation length between droplets, etc., and without any stray or overall errant jetting. In addition, the method of the invention enables extension of printhead lifetime and good storage stability. Printed images made according to the invention exhibit photographic quality and long term stability to environmental conditions such as light and ozone.

### DETAILED DESCRIPTION OF THE INVENTION

In order to meet the aforementioned advantages, the inventors have unexpectedly discovered that in order to print hundreds of pages using a printhead having a nozzle array comprising a plurality of nozzles having a small nozzle diameter and an ink composition containing particles, the particle size distribution of the particles must meet stringent criteria that depend upon the nozzle diameter. In particular, at least 90% by weight of the particles must have a diameter that is less than 1/120^{th} of the nozzle diameter. In a preferred embodiment, at least 90% by weight of the particles must have a diameter that is less than 1/150^{th} of the nozzle diameter, and even more preferably, less than 1/200^{th} of the nozzle diameter. Inks containing particles wherein 95% by weight of the particles meet the aforementioned criteria are preferable. When jetted with a printhead having nozzle arrays having small nozzle diameters, inks that meet these preferred criteria can be jetted for longer periods of time as compared to inks that do not.

The printhead has at least one nozzle array comprising nozzles that are 20 microns or less in diameter. In a preferred embodiment, the nozzles are less than 18 microns, and even more preferably, less than 16 microns. These small nozzle diameters are preferred because they are capable of producing droplets small enough for photographic-quality imaging and diagnostic medical imaging. Any nozzle diameter capable of generating droplets having an average drop volume of 5 pL or less is especially preferable in these applications. The printhead may have one nozzle array with nozzles meeting the diameter requirement or more than one nozzle array with nozzles meeting the diameter requirement as discussed above.

Any printhead known in the art of ink jet printing may be used. The printhead may have one or more nozzle arrays, each nozzle array being dedicated to jetting or ejecting the same ink composition or different ink compositions. For example, the printhead may consist of one nozzle array for printing a black ink; such printheads are often used in ink jet printers dedicated to printing only text, for example, fax machines or industrial labeling systems. In another example, the printhead may consist of three nozzle arrays, each nozzle array being dedicated to jetting cyan, yellow and magenta ink compositions respectively. Additionally a nozzle array may be dedicated to ejecting a clear ink or coating. The nozzles of a nozzle array for a given ink may be located in one discrete array or may be intermingled with the nozzles of another nozzle array. Examples of multicolor ink jet printing systems are used in desktop and wide format applications. The printhead may be provided as part of the printer, such as for desktop printers available from Epson America Inc., or as part of an integrated ink supply system comprising an ink supply and a replaceable printhead. That is, the printhead and ink supply may be integrated into a single unit (a type of ink supply system) that is not intended to be separated by a consumer. For example, an integrated ink supply system is employed in the DeskJet® 895Cxi, an ink jet printer available from Hewlett-Packard Co.

When the printhead is part of the printer the prinhead and ink supply are separate from each other. The printhead may be a permanent part of the printer, or it may be a replaceable part of the printer, thereby enabling the consumer to replace the printhead if it malfunctions. In this case the ink supply is separate from the printhead and may be replaced or replenished if the ink supply if the ink is depleted. A separate ink supply may be in the form of an on-board ink container or ink tank that resides in the carriage assembly of the printer where the printhead resides. An on-board ink container is connected directly to the printhead and therefore moves side to side with the printhead as an image is being printed. The ink supply may be remote from the carriage assembly, for example, in an off-board configuration in which an off-board ink container is separated from the carriage assembly. An off-board ink container may reside within the printer, for example, in typical wide format printers available from Encad, Inc., or it may reside separate from the printer, for example, in a 55-gallon drum which may be connected to a wide format printer or a continuous ink jet printing system.

The invention also provides an ink supply system comprising an ink supply and printed instructions directing the ink supply system be used with an ink jet printer capable of printing with an ink jet printhead having a nozzle array having a plurality of nozzles, and wherein the nozzles are 20 microns or less in diameter. The printed instructions may be on the packaging of the ink supply system. The printed instructions may be on a printed sheet sold with the ink supply system, either within the packaging of the ink supply system, or available from a source remote from the ink supply system such as an in-store display or a catalog. The instructions may also be printed on a web page with directions to use a specific ink supply with a specific printhead. The printed instructions may also be on some part of the ink supply system itself, such as on the ink supply.

Any type of printhead may be used including, but not limited to, drop-on-demand printheads which utilize piezoelectric transducers or thermal bubble formation, or continuous printheads which utilize electrostatic charging devices and deflector plates. The invention is particularly suitable for use with a thermal printhead. Examples of printheads useful in the invention include those used in Canon USA, Inc., Hewlett-Packard Co., and Epson America Inc. desktop and wide-format ink jet printers, and in printing systems described in U.S. 2003/0117465 A1; U.S. 2003/0043223 A1; U.S. Pat. No. 6,079,821; U.S. Pat. No. 6,450,619 B1; or U.S. Pat. No. 6,217,163 B 1. The printhead used in the present invention may be part of any type of conventional inkjet printing system that deposits one or more inks or fluids onto an image-recording element.

Any ink jet ink composition containing particles may be used in the invention, provided that at least 90% by weight of the particles have a size that is less than 1/120^{th} of the nozzle diameter of the nozzle array from which it is jetted. Preferred parameters are described above. For example, if a nozzle diameter is 20 microns, then at least 90% by weight of the pigment particles in a pigment-based ink must be less than (20 microns)(1/120^{th})=0.167 microns or 167 nm. Useful ink compositions also include those that contain particles wherein 95% by weight of the particles have a size that is less than 1/120^{th} of the nozzle diameter of the printhead from which it is jetted. It is preferred that substantially all of the particles are less than about 300 nm, and preferably less than about 150 nm, in order to eliminate detrimental effects of light scattering. The size of a particle includes all the components of a particle, such as polymer phase of a pigment/polymer particle, an encapsulating wall or other multi-phased particles.

The ink composition may be aqueous- or solvent-based, and in a liquid, solid or gel state at room temperature and pressure. Aqueous-based ink compositions are preferred because they are more environmentally friendly as compared to solvent-based inks, plus most printheads are designed for use with aqueous-based inks.

The ink composition may be colored with pigments, dyes, polymeric dyes, loaded-dye/latex particles, or any other types of colorants, or combinations thereof. In a preferred embodiment of the invention, pigment-based ink compositions are used because such inks render printed images having higher optical densities and better resistance to light and ozone as compared to printed images made from other types of colorants. The ink composition may be yellow, magenta, cyan, black, gray, red, violet, blue, green, orange, brown, etc.

A wide variety of organic and inorganic pigments, alone or in combination, may be used in the ink composition of the present invention. Pigments that may be used in the invention include those disclosed in, for example, U.S. Pat. Nos. 5,026,427; 5,086,698; 5,141,556; 5,160,370; and 5,169,436. The exact choice of pigments will depend upon the specific application and performance requirements such as color reproduction and image stability.

Pigments suitable for use in the invention include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

In a preferred embodiment of the invention, the pigment is C.I. Pigment Yellow 74, 128, 155; C.I. Pigment Red 122, 177, 202; C.I. Pigment Blue 15:3, the siloxane-bridged aluminum phthalocyanine, bis(phthalocyanylalumino) tetraphenyldisiloxane, represented by the following formula:
PcAl-O—[SiR₂—O]₂-AlPc
where R is a phenyl group and Pc is unsubstituted; C.I. Pigment Violet 23; or carbon black. The aforementioned pigments are preferred because they provide better color gamut as compared to those that are not preferred. In another preferred embodiment, cyan pigments are used because ink compositions containing these pigments are especially difficult to jet.

Pigment-based ink compositions useful in the invention may be prepared by any method known in the art of ink jet printing, provided that at least 90% by weight of the pigments have a size that is less than 1/120^{th} of the nozzle diameter of the nozzle array of the printhead from which it is jetted. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air-jet mill, an attritor, or a liquid interaction chamber. In the milling step (a), pigments are optionally suspended in a medium which is typically the same as or similar to the medium used to dilute the pigment dispersion in step (b). Inert milling media are optionally present in the milling step (a) in order to facilitate break up of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

A dispersant is optionally present in the milling step (a) in order to facilitate break up of the pigments into primary particles. For the pigment dispersion obtained in step (a) or the ink composition obtained in step (b), a dispersant is optionally present in order to maintain particle stability and prevent settling. Dispersants suitable for use in the invention include, but are not limited to, those commonly used in the art of ink jet printing. For aqueous pigment-based ink compositions, useful dispersants include anionic, cationic or nonionic surfactants such as sodium dodecylsulfate, or potassium or sodium oleoylmethyltaurate as described in, for example, U.S. Pat. No. 5,679,138; U.S. Pat. No. 5,651,813 or U.S. Pat. No. 5,985,017.

Polymeric dispersants are also useful in aqueous pigment-based ink compositions of the invention. Polymeric dispersants may be added to the pigment dispersion prior to or during the milling step (a) and include polymers such as homopolymers and copolymers; anionic, cationic or nonionic polymers; or random, block, branched or graft polymers. Polymeric dispersants particularly useful in the invention include random and block copolymers having hydrophilic and hydrophobic portions; see for example, U.S. Pat. No. 4,597,794; U.S. Pat. No. 5,085,698; U.S. Pat. No. 5,519,085; U.S. Pat. Nos. 5,272,201; 5,172,133; or U.S. Pat. No. 6,043,297; and graft copolymers; see for example, U.S. Pat. No. 5,231,131; U.S. Pat. No. 6,087,416; U.S. Pat. No. 5,719,204; or U.S. Pat. No. 5,714,538.

Composite colorant particles having a colorant phase and a polymer phase are also useful in aqueous pigment-based inks of the invention. Composite colorant particles are formed by polymerizing monomers in the presence of pigments; see for example, U.S. Ser. Nos. 10/446,013; 10/446,059; or 10/665,960. Microencapsulated-type pigment particles are also useful and consist of pigment particles coated with a resin film; see for example U.S. Pat. No. 6,074,467.

Aqueous pigment-based ink compositions of the invention may also contain self-dispersed colorants in which the surfaces of pigment particles are chemically functionalized such that a separate dispersant is not necessary; see for example, U.S. Pat. No. 6,494,943 B1 and U.S. Pat. No. 5,837,045.

Dyes suitable for use in the invention include, but are not limited to, those commonly used in the art of inkjet printing. For aqueous-based ink compositions, such dyes include water-soluble reactive dyes, direct dyes, anionic dyes, cationic dyes, acid dyes, food dyes, metal-complex dyes, phthalocyanine dyes, anthraquinone dyes, anthrapyridone dyes, azo dyes, rhodamine dyes, solvent dyes and the like. Typical examples of dyes include C.I. Direct Yellow 86, 107, 132, 173; Acid Yellow 17, 23; C.I. Reactive Red 23, 24, 31, 120, 180, 241; Acid Red 35, 52, 249, 289, 388; Direct Red 227; CAS No. 224628-70-0 sold as JPD Magenta EK-1 Liquid from Nippon Kayaku Kabushiki Kaisha; CAS No. 153204-88-7 sold as Intrajet® Magenta KRP from Crompton and Knowles Colors; the metal azo dyes disclosed in U.S. Pat. Nos. 5,997,622 and 6,001,161; C.I. Direct Blue 86, 199, 307; Acid Blue 9; Reactive Black 31; Direct Black 19, 154, 168; Food Black 2; Fast Black 2, Solubilized Sulfur Black 1 (Duasyn® Black SU-SF).

Also useful in the invention are polymeric dyes or loaded-dye/latex particles. Examples of polymeric dyes are described in U.S. Pat. No. 6,457,822 Bland references therein. Examples of loaded-dye/latex particles are described in U.S. Pat. No. 6,431,700 B1 and U.S. application Ser. Nos. 10/393,235; 10/393,061; 10/264,740; 10/020,694; and 10/017,729.

The colorants used in the ink composition of the invention may be present in any effective amount, generally from 0.1 to 10% by weight, and preferably from 0.5 to 6% by weight.

The ink composition of the invention may contain non-colored particles such as inorganic or polymeric particles in order to improve gloss differential, light and/or ozone resistance, waterfastness, rub resistance and various other properties of a printed image; see for example, U.S. Pat. No. 6,598,967 B1 or U.S. Pat. No. 6,508,548 B2. Colorless ink compositions that contain non-colored particles and no colorant may also be used. Colorless ink compositions are often used in the art as “fixers” or insolubilizing fluids that are printed under, over, or with colored ink compositions in order to reduce bleed between colors and waterfastness on plain paper; see for example, U.S. Pat. No. 5,866,638 or U.S. Pat. No. 6,450,632 B1. Colorless inks are also used to provide an overcoat to a printed image, usually in order to improve scratch resistance and waterfastness; see for example, U.S. 2003/0009547 A1 or E.P. 1,022,151 A1. Colorless inks are also used to reduce gloss differential in a printed image; see for example, U.S. Pat. No. 6,604,819 B2; U.S. 2003/0085974 A1; U.S. 2003/0193553 A1; or U.S. 2003/0189626 A1.

Examples of inorganic particles useful in the invention include, but are not limited to, alumina, boehmite, clay, calcium carbonate, titanium dioxide, calcined clay, aluminosilicates, silica, or barium sulfate.

For aqueous-based inks, polymeric particles useful in the invention include water-dispersible polymers generally classified as either addition polymers or condensation polymers, both of which are well-known to those skilled in the art of polymer chemistry. Examples of polymer classes include acrylics, styrenics, polyethylenes, polypropylenes, polyesters, polyamides, polyurethanes, polyureas, polyethers, polycarbonates, polyacid anhydrides, and copolymers consisting of combinations thereof.

Preferred polymeric particles are styrene-acrylic copolymers sold under the trade names Joncryl® (S.C. Johnson Co.), Ucar™ (Dow Chemical Co.), Jonrez® (MeadWestvaco Corp.), and Vancryl® (Air Products and Chemicals, Inc.); sulfonated polyesters sold under the trade name Eastman AQ® (Eastman Chemical Co.); and polyurethanes. These polymeric particles are preferred because they are compatible in typical aqueous-based ink compositions, and because they render printed images that are highly durable towards physical abrasion, light and ozone.

The non-colored particles used in the ink composition of the invention may be present in any effective amount, generally from 0.01 to 20% by weight, and preferably from 0.01 to 6% by weight. The exact choice of non-colored particles will depend upon the specific application and performance requirements of the printed image.

Ink compositions useful in the invention include humectants and/or co-solvents in order to prevent the ink composition from drying out or crusting in the nozzles of the printhead, aid solubility of the components in the ink composition, or facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, diethylene glycol, triethylene glycol, tetraethylene glycol, propylene glycol, polyethylene glycol, glycerol, 2-methyl-2,4-pentanediol, 1,2,6-hexanetriol, 2-ethyl-2-hydroxymethyl-1,3-propanediol, 1,5 pentanediol, 1,2-hexanediol, and thioglycol; (3) lower mono- and di-alkyl ethers derived from the polyhydric alcohols; (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol. Typical aqueous-based ink compositions useful in the invention may contain, for example, the following components based on the total weight of the ink: water 20-95%, humectant(s) 5-70%, and co-solvent(s) 2-20%.

Other components present in the ink composition of the invention include surfactants, defoamers, biocides, buffering agents, conductivity enhancing agents, anti-kogation agents, drying agents, waterfast agents, chelating agents, binders such as water soluble polymers, light stabilizers, or ozone stabilizers.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. Acceptable viscosities are no greater than 20 cP, and preferably in the range of about 1.0 to 6.0 cP. Acceptable surface tensions are no greater than 60 dynes/cm, and preferably in the range of 28 dynes/cm to 45 dynes/cm.

The invention can be used in conjunction with any type of image-recording element, including but not limited to plain paper, vinyl, canvas, and specialty paper designed specifically for use with ink jet printing.

The following example is provided to illustrate the invention.

### EXAMPLE

Measurement of Pigment Particle Sizes

Particle sizes for each of the pigment dispersions and inks described below were measured using a Microtrac® Ultrafine Particle Analyzer 250 from Microtrac Inc. Particle sizes are reported as UPA50 and/or UPA90. As used herein, UPA50 refers to the median particle size such that 50% by weight of the particles have a particle size less than that number. UPA90 means that at least 90% by weight of the particles have a particle size less than that number.

Preparation of Ink Compositions

Cyan Ink C-1

A mixture of 325 g of polymeric beads having mean diameter of 50 μm, 30.0 g of Pigment Blue 15:3 (Sun Chemical Corp.); 10.5 g of potassium oleoyl methyl taurate (KOMT) and 209.5 g of deionized water was prepared. These components were milled for 8 hours in a double walled vessel at room temperature using a high-energy media mill manufactured by Morehouse-Cowles Hochmeyer. The mixture was filtered through a 4-8 μm Buchner funnel to remove the polymeric beads, and the resulting filtrate diluted to give a Cyan Pigment Dispersion having approximately 10 wt. % final concentration of pigment. UPA50 was approximately 40 nm. Proxel® GXL (Avecia Corp.) was added at an amount necessary to give 230 ppm concentration.

Cyan Ink C-1 was prepared using the Cyan Pigment Dispersion described above to give 2.48 wt. % of pigment relative to the total weight of the ink. Other additives included diethylene glycol at 6.8 wt. %, glycerol at 2.7 wt. %, ethyleneglycol monobutylether (Dowanol® DB from Dow Chemical Co.) at 2.5 wt. %, Surfynol® 465 (Air Products and Chemicals, Inc.) at 0.2 wt. %, and styrene-acrylic copolymer TruDot™ IJ-4655 (MeadWestvaco Corp.), at 1.733 wt. % relative to the total weight of the ink. The ink was filtered through a membrane having a pore size of 3.0 μm.

Yellow Ink Y-1

A Yellow Pigment Dispersion was prepared the same as the Cyan Pigment Dispersion described above except that Pigment Yellow 155 (Clariant Corp.) was used instead of Pigment Blue 15:3. The final concentration of pigment was approximately 10 wt. %, and UPA50 was about 10 nm.

Yellow Ink Y-1 was prepared the same as Cyan Ink C-1 except that the Yellow Pigment Dispersion was used at 4.2 wt. % instead of the Cyan Pigment Dispersion, diethylene glycol was used at 3.1 wt. %, glycerol was used at 1.8 wt %, and TruDot™ IJ-4655 was used at 2.94 wt. %.

Black Ink K-1

Black Ink K-1 was the black pigment ink for Hewlett-Packard Deskjet ink jet printers; part number 51645A. The ink was extracted from cartridges and used as is. UPA50 was 100 nm and UPA90 was 150 nm.

Cyan Ink C-2

Cyan Ink C-2 was the cyan pigment ink for the Epson Stylus Pro 9600 ink jet printer, UltraChrome™ T5442. Ink was extracted from cartridges and used as is. UPA50 was 90 nm and UPA90 was 170 nm.

Particle size distributions of the inks are summarized in Table 1.

TABLE 1

| Ink | UPA50 (nm) | UPA90 (nm) |
|---|---|---|
| C-1 | 43 | 70 |
| Y-1 | 11 | 19 |
| K-1 | 100 | 150 |
| C-2 | 90 | 170 |

Printing

A test page consisting of a density patch measuring approximately 50 mm wide×253 mm long (19.6 square inches) was created using Adobe PhotoShop v4.0 software (Adobe Systems) in the RGB mode. Printing was carried out at 100% C, 100% M, 100% Y, or 100% K using the Canon s520 and the Canon i950 desktop ink jet printers. For the s520, settings utilized were Media Type=Transparency, Color Adjust=Manual, Graphics-Normal. For the i950, settings utilized were Media Type=Plain Paper, Color Adjust=Manual-None.

The Canon s520 and i950 printers each consist of separate C, M, Y and K ink cartridges connected to a single printhead unit via inlet ports. The ink cartridges were removed and each of the above inks was fed directly to the printhead unit using a bulk ink supply system. This avoided the need to continually refill ink cartridges during lengthy testing procedures. The use of a bulk ink supply system also eliminated additional filtration of the inks by sponges present in the ink cartridges, and thus eliminated a potential source of ambiguity in the data.

Nozzle diameters (ND) for the Canon s520 and i950 printers were determined using visual microscopy and are summarized in Table 2.

TABLE 2

| Printer/ | | | ND | ND × | ND × | ND × |
|---|---|---|---|---|---|---|
| Channel | Printer | Channel | (micron) | 1/120^{th} | 1/150^{th} | 1/200^{th} |
| P-1 | Canon | K | 27 | .225 | .180 | .135 |
| | s520 | | | | | |
| P-2 | Canon | Y | 17 | .142 | .113 | .085 |
| | s520 | | | | | |
| P-3 | Canon | Y | 15 | .125 | .100 | .075 |
| | i950 | | | | | |
| P-4 | Canon | M | 15 | .125 | .100 | .075 |
| | i950 | | | | | |
| P-5 | Canon | K | 15 | .125 | .100 | .075 |
| | i950 | | | | | |
| P-6 | Canon | C | 15 | .125 | .100 | .075 |
| | i950 | | | | | |

Evaluation of Ink Reliability

The reliability of each of the inks was evaluated by printing test pages consisting of the density patch described above and determining the number of pages that could be printed before printhead nozzles were clogged by the pigment particles. Printhead nozzles were considered clogged if there were blanks or problem areas (streaking, banding, etc.) in the density patch. Clogging was subsequently verified by running the printer's nozzle-check maintenance cycle. An ink was considered reliable if a minimum of about 100 test pages could be printed without any printhead nozzles clogging. The test was stopped after 500 test pages were printed. The results are shown in Table 3.

TABLE 3

| | | | [ND (micron)/ | Test Pages |
|---|---|---|---|---|
| Example | Ink | Printhead | UPA90 (nm)] × 1000 | Printed |
| Inventive | C-1 | P-1 | 386 | 500 |
| Example 1 | | | | |
| Inventive | C-1 | P-2 | 242 | 500 |
| Example 2 | | | | |
| Inventive | C-1 | P-3 | 214 | 500 |
| Example 3 | | | | |
| Inventive | Y-1 | P-4 | 789 | 500 |
| Example 4 | | | | |
| Inventive | K-1 | P-1 | 180 | 374 |
| Example 5 | | | | |
| Comparative | K-1 | P-2 | 113 | 26 |
| Example 1 | | | | |
| Comparative | K-1 | P-5 | 100 | 8 |
| Example 2 | | | | |
| Comparative | C-2 | P-6 | 88 | 8 |
| Example 3 | | | | |

The results in Table 3 show that many more test pages could be printed with the Inventive Examples as compared to the Comparative Examples. Specifically, reliability was obtained if the UPA90 of an ink composition containing particles was less than 1/120^{th} of the printhead nozzle diameter.

Although the invention has been described in detail with reference to certain preferred embodiments for the purpose of illustration, it is to be understood that variations and modifications can be made by those skilled in the art without departing from the spirit and scope of the invention.

The invention has been described in detail with particular reference to certain preferred embodiments thereof, but it will be understood that variations and modifications can be effected within the spirit and scope of the invention.

1. An ink jet printing method comprising the steps of:
A) providing an ink jet printer that is responsive to digital data signals;
B) providing an ink jet printhead comprising a nozzle array comprising a plurality of nozzles, said nozzle array being dedicated to ejecting a given ink jet ink composition, wherein said nozzles are 20 microns or less in diameter;
C) supplying said printhead with said given ink jet ink composition, said ink jet ink composition comprising particles wherein at least 90% by weight of said particles have a diameter that is less than 1/120^{th} of the diameter of said nozzles; and
D) printing using said given ink jet ink composition in response to said digital data signals.

2. The ink jet printing method of claim 1 wherein said nozzles are less than 18 microns in diameter.

3. The ink jet printing method of claim 1 wherein said nozzles are less than 16 microns in diameter.

4. The ink jet printing method of claim 1 wherein at least 90% of the particles are less than 1/150^{th} of the diameter of the nozzles.

5. The ink jet printing method of claim 2 wherein at least 90% of the particles are less than 1/150^{th} of the diameter of the nozzles.

6. The ink jet printing method of claim 1 wherein at least 90% of the particles are less than 1/200^{th} of the diameter of the nozzles.

7. The ink jet printing method of claim 2 wherein at least 90% of the particles are less than 1/200^{th} of the diameter of the nozzles.

8. The ink jet printing method of claim 1 wherein the printhead comprises more than one nozzle array, each nozzle array being dedicated to ejecting ink of a different given ink jet ink composition, wherein each given ink jet ink composition comprises particles wherein at least 90% of the particles are less than 1/120^{th} of the diameter of the nozzles of the dedicated nozzle array.

9. The ink jet printing method of claim 8 wherein the printhead comprises at least three nozzle arrays, said arrays being dedicated to ejecting cyan, yellow and magenta ink compositions respectively.

10. The ink jet printing method of claim 1 wherein the particles are colorant particles.

11. The ink jet printing method of claim 10 wherein the particles are pigments.

12. The ink jet printing method of claim 11 wherein the particles are cyan pigments.

13. The ink jet printing method of claim 1 wherein the printhead is provided as part of the printer.

14. The ink jet printing method of claim 1 wherein the printhead is provided by an ink supply system comprising an ink supply and a printhead.

15. The ink jet printing method of claim 1 wherein the given ink jet ink composition is ejected from the nozzles of the nozzle array in droplets having an average drop volume of 5 pL or less.

16. The ink jet printing method of claim 1 wherein the ink jet ink composition is an aqueous-based ink composition comprising a humectant and/or co-solvent.

17. An ink supply system comprising printed instructions directing that the ink jet supply system be used with an ink jet printer comprising an ink jet printhead comprising a nozzle array comprising a plurality of nozzles, said nozzle array being dedicated to ejecting a given ink jet ink composition, wherein the nozzles are 20 microns or less in diameter; and said ink jet supply system further comprising said given ink jet ink composition comprising particles wherein at least 90% of the particles are less than 1/120^{th} of the diameter of said nozzles.

18. The ink supply system of claim 17 wherein said nozzles are less than 18 microns in diameter.

19. The ink supply system of claim 17 wherein said nozzles are less than 16 microns in diameter.

20. The ink supply system of claim 17 wherein at least 90% of the particles are less than 1/150^{th} of the diameter of said nozzles.

21. The ink supply system of claim 17 wherein at least 90% of the particles are less than 1/200^{th} of the diameter of said nozzles.

22. The ink supply system of claim 18 wherein at least 90% of the particles are less than 1/200^{th} of the diameter of said nozzles.

23. The ink supply system of claim 17 wherein the printhead comprises more than one nozzle array, each nozzle array being dedicated to ejecting ink of a different given ink jet ink composition, wherein each given ink jet ink composition comprises particles wherein at least 90% of the particles are less than 1/120^{th} of the diameter of the nozzles of the dedicated nozzle array.

24. The ink supply system of claim 23 wherein the printhead comprises at least three nozzle arrays, said arrays being dedicated to ejecting a cyan, yellow and magenta ink compositions respectively.

25. The ink supply system of claim 17 wherein the particles are pigments.

26. The ink supply system of claim 25 wherein the particles are cyan pigments.

27. The ink supply system of claim 17 wherein the ink jet ink composition further comprises an aqueous-based ink composition comprising a humectant and/or co-solvent.

28. The ink supply system of claim 17 wherein said instructions are on the packaging of the supply system.

29. The ink supply system of claim 17 wherein said instructions are on the ink supply.

30. The ink supply system of claim 17 wherein said instructions are on a printed sheet sold with the ink supply system.

31. The ink supply system of claim 17 wherein said instructions are in a source remote from the ink supply system.

32. An ink jet ink supply system comprising an integrated ink jet ink supply and a printhead, wherein said printhead comprises a nozzle array comprising a plurality of nozzles, said nozzle array being dedicated to ejecting a given ink jet ink composition, wherein said nozzles are 20 microns or less in diameter; and wherein said ink jet ink supply further comprises the given ink jet ink composition comprising particles wherein at least 90% of the particles are less than 1/120^{th} of the diameter of said nozzles.

33. The ink supply system of claim 32 wherein said nozzles are less than 18 microns in diameter.

34. The ink supply system of claim 32 wherein said nozzles are less than 16 microns in diameter.

35. The ink supply system of claim 32 wherein at least 90% of the particles are less than 1/150^{th} of the diameter of said nozzles.

36. The ink supply system of claim 32 wherein at least 90% of the particles are less than 1/120^{th} of the diameter of said nozzles.

37. The ink supply system of claim 33 wherein at least 90% of the particles are less than 1/200^{th} of the diameter of said nozzles.

38. The ink supply system of claim 32 wherein the printhead comprises more than one nozzle array, each nozzle array being dedicated to ejecting ink of a different given ink jet ink composition, wherein each given ink jet ink composition comprises particles wherein at least 90% of the particles are less than 1/120^{th} of the diameter of the nozzles of the dedicated nozzle array.

39. The ink supply system of claim 38 wherein the printhead comprises at least three nozzle arrays, said arrays being dedicated to ejecting a cyan, yellow and magenta ink compositions respectively.

40. The ink supply system of claim 32 wherein the particles are pigments.

41. The ink supply system of claim 40 wherein the particles are cyan pigments.

42. The ink supply system of claim 32 wherein the ink jet ink composition further comprises an aqueous-based ink composition comprising a humectant and/or co-solvent.

43. An ink jet printer comprising a printhead and an ink jet ink supply, wherein said printhead comprises a nozzle array comprising a plurality of nozzles, said nozzle array being dedicated to ejecting a given ink jet ink composition, wherein said nozzles are 20 microns or less in diameter; and wherein said ink jet ink supply further comprises the given ink jet ink composition comprising particles wherein at least 90% of the particles are less than 1/120^{th} of the diameter of said nozzles.

44. The printer of claim 43 wherein said nozzles are less than 18 microns in diameter.

45. The printer of claim 43 wherein said nozzles are less than 16 microns in diameter.

46. The printer of claim 43 wherein at least 90% of the particles are less than 1/150^{th} of the diameter of said nozzles.

47. The printer of claim 43 wherein at least 90% of the particles are less than 1/200^{th} of the diameter of said nozzles.

48. The printer of claim 47 wherein at least 90% of the particles are less than 1/200^{th} of the diameter of said nozzles.

49. The printer of claim 43 wherein the printhead comprises more than one nozzle array, each nozzle array being dedicated to ejecting ink of a different given ink jet ink composition, wherein each given ink jet ink composition comprises particles wherein at least 90% of the particles are less than 1/120^{th} of the diameter of the nozzles of the dedicated nozzle array.

50. The printer of claim 49 wherein the printhead comprises at least three nozzle arrays, said arrays being dedicated to ejecting a cyan, yellow and magenta ink compositions respectively.

51. The printer of claim 43 wherein the particles are pigments.

52. The printer of claim 51 wherein the particles are cyan pigments.

53. The printer of claim 43 wherein the ink jet ink composition further comprises an aqueous-based ink composition comprising a humectant and/or co-solvent.

54. A method of replenishing the ink supply to a printer comprising a printhead comprising a nozzle array comprising a plurality of nozzles, said nozzle array being dedicated to ejecting a given ink jet ink composition, wherein said nozzles are 20 microns or less in diameter; said method comprising taking an ink supply comprising said given ink jet ink composition comprising particles wherein at least 90% of the particles are less than 1/120^{th} of the diameter of said nozzles and replenishing the ink supply of the printer.

55. The method of claim 1 wherein the printhead is a thermal printhead.

56. The ink supply system of claim 17 wherein the printhead is a thermal printhead.

57. The ink supply system of claim 32 wherein the printhead is a thermal printhead.

58. The printer of claim 43 wherein the printhead is a thermal printhead.
